(19) United States
(12) Patent Application Publication
(10) Pub. No.: US 2013/0105003 A1
(43) Pub. Date: May 2, 2013

(54) HEATED ARTICULATING TUBING

(71) Applicant: GRACO MINNESOTA INC., Minneapolis, MN (US)

(72) Inventors: Paul R. Quam, Brooklyn Center, MN (US); Daniel P. Ross, Maplewood, MN (US)

(73) Assignee: GRACO MINNESOTA INC., Minneapolis, MN (US)

(21) Appl. No.: 13/660,022

(22) Filed: Oct. 25, 2012

Related U.S. Application Data
(60) Provisional application No. 61/552,229, filed on Oct. 27, 2011.

(51) Int. Cl. F16L 53/00

(52) U.S. Cl. 137/334; 138/32

(57) ABSTRACT

A hot melt dispensing system comprises a container, a melter, a feed system, a dispensing system and a fluid line. The container stores hot melt pellets. The feed system transports hot melt pellets from the container to the melter. The melter is capable of heating hot melt pellets into liquid hot melt adhesive. The fluid line connects the melter and the dispensing system. The dispensing system administers liquid hot melt adhesive from the melter. The fluid line comprises a rigid segment and a heating element connected to the rigid segment. In another embodiment, the fluid line comprises first and section portions connected by an articulating joint.

### CROSS-REFERENCE TO RELATED APPLICATION(S)

This application is a non-provisional of U.S. Application Ser. No. 61/552,229, filed on Oct. 27, 2011.

### BACKGROUND

The present disclosure relates generally to systems for dispensing hot melt adhesive. More particularly, the present disclosure relates to heated tubing for connecting pumps with hot melt adhesive dispensers.

Hot melt dispensing systems are typically used in manufacturing assembly lines to automatically disperse an adhesive used in the construction of packaging materials such as boxes, cartons and the like. Hot melt dispensing systems conventionally comprise a material tank, heating elements, a pump and a dispenser. Solid polymer pellets are melted in the tank using a heating element before being supplied to the dispenser by the pump. Because the melted pellets will re-solidify into solid form if permitted to cool, the melted pellets must be maintained at temperature from the tank to the dispenser. This typically requires placement of heating elements in the tank, the pump and the dispenser, as well as heating any tubing or hoses that connect those components. Furthermore, conventional hot melt dispensing systems typically utilize tanks having large volumes so that extended periods of dispensing can occur after the pellets contained therein are melted. However, the large volume of pellets within the tank requires a lengthy period of time to completely melt, which increases start-up times for the system. For example, a typical tank includes a plurality of heating elements lining the walls of a rectangular, gravity-fed tank such that melted pellets along the walls prevents the heating elements from efficiently melting pellets in the center of the container. The extended time required to melt the pellets in these tanks increases the likelihood of “charring” or darkening of the adhesive due to prolonged heat exposure.

### SUMMARY

According to the present invention, a hot melt dispensing system comprises a container, a melter, a feed system, a dispensing system and a fluid line. The container stores hot melt pellets. The feed system transports hot melt pellets from the container to the melter. The melter is capable of heating hot melt pellets into liquid hot melt adhesive. The fluid line connects the melter and the dispensing system. The dispensing system administers liquid hot melt adhesive from the melter. The fluid line comprises a rigid segment and a heating element connected to the rigid segment. In another embodiment, the fluid line comprises first and section portions connected by an articulating joint.

### BRIEF DESCRIPTION OF THE DRAWINGS

FIG. 1 is a schematic view of a system for dispensing hot melt adhesive including a hot melt dispenser.

FIG. 2 is a schematic of the a melt dispensing system wherein the hot melt dispenser of FIG. 1 is implemented within a container erector system using heated, rigid tubing connected at an articulating joint.

FIG. 3 is a perspective view of a first embodiment of the articulating joint of FIG. 2 comprising a pivoting joint connecting the heated, rigid tubing.

FIG. 4 is a cross-sectional view of a second embodiment of the articulating joint of FIG. 2 comprising a swivel joint connecting the heated, rigid tubing.

FIG. 5 is a perspective view of a third embodiment of the articulating joint of FIG. 2 comprising a flexible coupling connecting the heated, rigid tubing.

### DETAILED DESCRIPTION

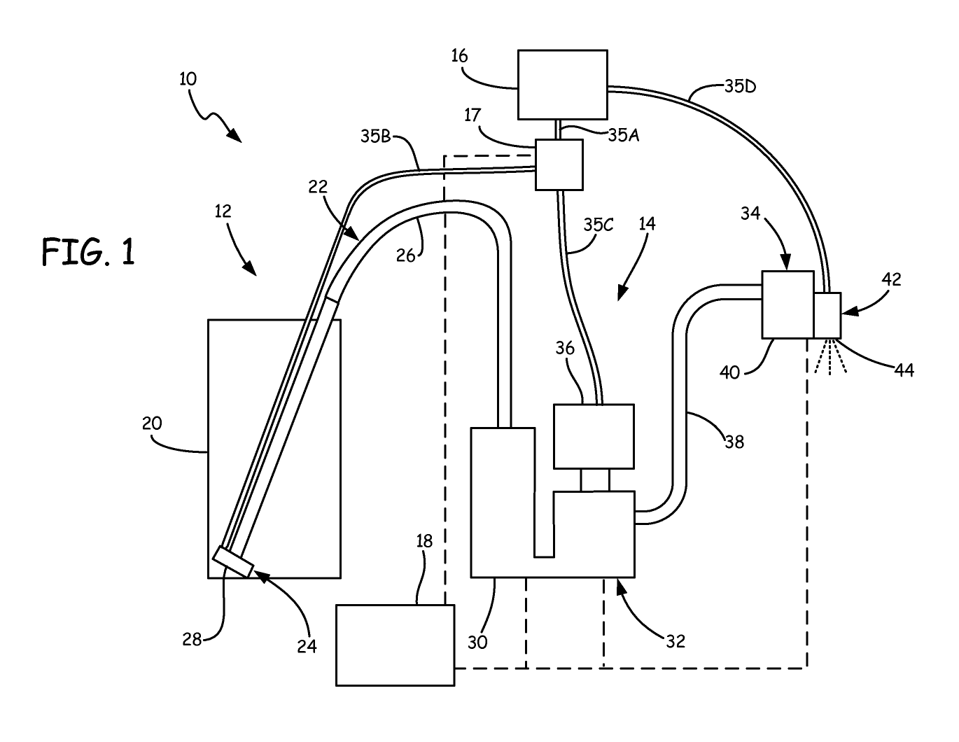

FIG. 1 is a schematic view of system 10, which is a system for dispensing hot melt adhesive. System 10 includes cold section 12, hot section 14, air source 16, air control valve 17, and controller 18. In the embodiment shown in FIG. 1, cold section 12 includes container 20 and feed assembly 22, which includes vacuum assembly 24, feed hose 26, and inlet 28. In the embodiment shown in FIG. 1, hot section 14 includes melt system 30, pump 32, and dispenser 34. Air source 16 is a source of compressed air supplied to components of system 10 in both cold section 12 and hot section 14. Air control valve 17 is connected to air source 16 via air hose 35A, and selectively controls air flow from air source 16 through air hose 35B to vacuum assembly 24 and through air hose 35C to motor 36 of pump 32. Air hose 35D connects air source 16 to dispenser 34, bypassing air control valve 17. Controller 18 is connected in communication with various components of system 10, such as air control valve 17, melt system 30, pump 32, and/or dispenser 34, for controlling operation of system 10.

Components of cold section 12 can be operated at room temperature, without being heated. Container 20 can be a hopper for containing a quantity of solid adhesive pellets for use by system 10. Suitable adhesives can include, for example, a thermoplastic polymer glue such as ethylene vinyl acetate (EVA) or metallocene. Feed assembly 22 connects container 20 to hot section 14 for delivering the solid adhesive pellets from container 20 to hot section 14. Feed assembly 22 includes vacuum assembly 24 and feed hose 26. Vacuum assembly 24 is positioned in container 20. Compressed air from air source 16 and air control valve 17 is delivered to vacuum assembly 24 to create a vacuum, inducing flow of solid adhesive pellets into inlet 28 of vacuum assembly 24 and then through feed hose 26 to hot section 14. Feed hose 26 is a tube or other passage sized with a diameter substantially larger than that of the solid adhesive pellets to allow the solid adhesive pellets to flow freely through feed hose 26. Feed hose 26 connects vacuum assembly 24 to hot section 14.

Solid adhesive pellets are delivered from feed hose 26 to melt system 30. Melt system 30 can include a container (not shown) and resistive heating elements (not shown) for melting the solid adhesive pellets to form a hot melt adhesive in liquid form. Melt system 30 can be sized to have a relatively small adhesive volume, for example about 0.5 liters, and configured to melt solid adhesive pellets in a relatively short period of time. Pump 32 is driven by motor 36 to pump hot melt adhesive from melt system 30, through supply hose 38, to dispenser 34. Motor 36 can be an air motor driven by pulses of compressed air from air source 16 and air control valve 17. Pump 32 can be a linear displacement pump driven by motor 36. In the illustrated embodiment, dispenser 34 includes manifold 40 and module 42. Hot melt adhesive from pump 32 is received in manifold 40 and dispensed via dispensing module 42. Dispenser 34 can selectively discharge hot melt adhesive whereby the hot melt adhesive is sprayed out outlet 44 of module 42 onto an object, such as a package, a case, or another object benefiting from hot melt adhesive dispensed by system 10. Module 42 can be one of multiple modules that are part of dispenser 34. In an alternative embodiment, dispenser 34 can have a different configuration, such as a handheld gun-type dispenser. Some or all of the components in hot section 14, including melt system 30, pump 32, supply hose 38, and dispenser 34, can be heated to keep the hot melt adhesive in a liquid state throughout hot section 14 during the dispensing process.

System 10 can be part of an industrial process, for example, for packaging and sealing cardboard packages and/or cases of packages. In alternative embodiments, system 10 can be modified as necessary for a particular industrial process application. For example, in one embodiment (not shown), pump 32 can be separated from melt system 30 and instead attached to dispenser 34. Supply hose 38 can then connect melt system 30 to pump 32.

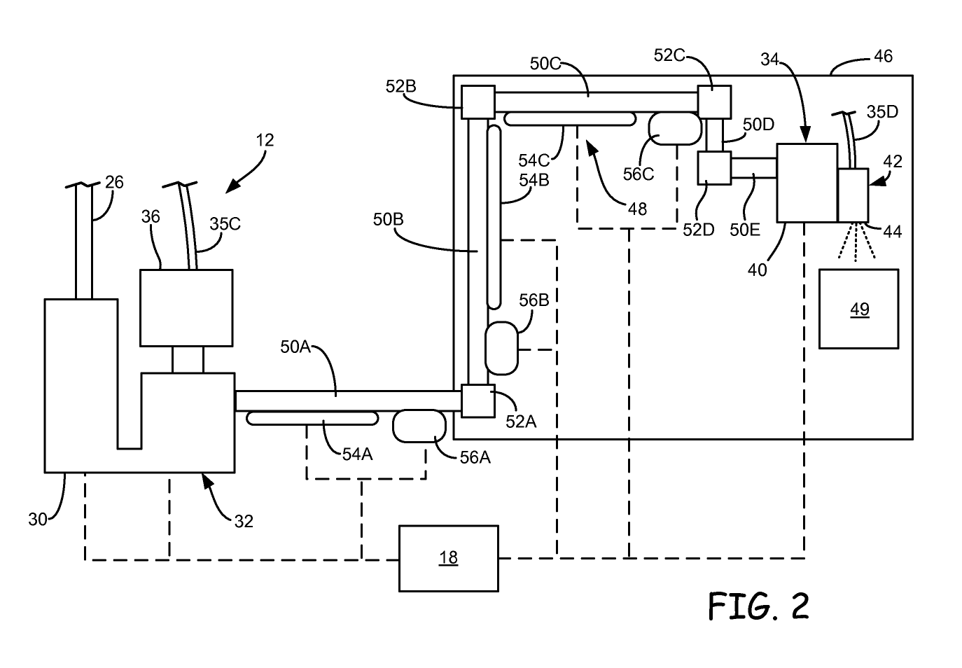

FIG. 2 is a schematic of hot melt dispensing system 10 of FIG. 1 wherein hot melt dispenser 34 is implemented within container erector system 46 using heated articulating tubing system 48 of the present invention. Melt system 30, pump 32, dispenser 34 and motor 36 are configured the same as in FIG. 1. However, in FIG. 2 hose 38 is replaced by heated articulating tubing system 48, and dispenser 34 is positioned inside container erector system 46 to apply hot melt adhesive to container 49. The outlet of pump 32 is connected to the inlet of manifold 40 via tube sections 50A-50E and joints 52A-52D. Tube sections 50A-50C include heating elements 54A-54C, and temperature sensors 56A-56C, respectively. Tube sections 50D and 50E may also include heating elements and temperature sensors, but they are not shown in FIG. 2 for simplicity.

Liquefied hot melt adhesive from melt system 30 is drawn into pump 32 and pumped under pressure to heated articulating tubing system 48. Tube section 50A extends from pump 32 to joint 52A within container erector 46. Joint 52A fluidly connects tube section 50A to tube section 50B. Joint 52B fluidly connects tube section 50B to tube section 50C within container erector 46. Joint 52C fluidly connects tube section 50C to tube section 50D within container erector 46. Joint 52D fluidly connects tube section 50D to tube section 50E within container erector 46. Tube section 50D fluidly connects to manifold 40 of dispenser 34. Module 42 of dispenser 34 receives hot melt adhesive from manifold 40 such that molten hot melt adhesive from orifice 44 can be applied to container 49.

As discussed with reference to FIG. 1, melt system 30 converts solid hot melt adhesive pellets to a liquid hot melt adhesive. Pump 32 includes heating elements as are known in the art to maintain the hot melt adhesive in a molten state. Heating elements 54A-54C maintain the hot melt adhesive in liquid form within heated articulating tubing system 48 to maintain the adhesive above its melt temperature when it arrives at dispenser 34. Dispenser 34 may also include heating elements as needed. Heating elements 54A-54C and temperature sensors 56A-56C are connected to controller 18. Controller 18 controls operation of heating elements 54A-54C during all phases of operation of system 12. For example, some or all of heating elements 54A-54C may be operated at different times during start-up, operation and shut-down of system 12 to conserve energy or apply concentrated heating. Controller 18 activates heating elements 54A-54C based on feedback from temperature sensors 56A-56C.

Container erector 46 may comprise any container erector system as is known in the art. In one embodiment, container erector 46 builds and assembles boxes from flattened pieces of cardboard. For example, U.S. Pat. Nos. 4,018,143 and 4,798,571 describe examples of container erector systems that may benefit from the present invention. In some hot melt dispensing systems, the container erector is mounted so as to be stationary with reference to the pump. Even in hot melt dispensing systems without container erectors, the dispenser can be mounted stationary with respect to the pump. Container erector systems often include tight, small, enclosed or otherwise cramped spaces where dispensers, such as dispenser 34, need to be mounted. Thus, in conventional hot melt dispensing systems, flexible hoses are used connect the dispenser to the pump. However, for dispensers that are stationary, it is not necessary for the hoses to have flexibility after the system is installed. Furthermore, the elasticity of common flexible hoses induces low-cycle fatigue into heating elements and sensors mounted on the hoses as the pressures within the hoses change during operation of the system. Flexible hoses have an additional drawback in that hot melt adhesive can have a tendency to cake on the inside of the hoses, which leads to the adhesive charring at such locations. If the flexible hose is jostled or bent, the charred adhesive can break loose and sully the molten hot melt adhesive flowing through the hose to the dispenser.

Heated articulating tubing system 48 of the present invention permits dispenser 34 to be mounted in a tight or enclosed space that is typically stationary. Tube sections 50A-50D provide rigid fluid conveying bodies, such as pipes, conduits or ducts, that provide stiff platforms for mounting heating elements 54A-54C and temperature sensors 56A-56C. Joints 52A-52D permit tube sections 50A-50D to be arranged in the desired orientation with respect to each other so that dispenser 34 can be located in the desired position with respect to pump 32. Joints 52A-52D permit tube sections 50A-50D to rotate, pivot or flex with respect to tube sections connected thereto. For a stationary system, once dispenser 34 is installed within container erector 46, joints 52A-52D are no longer needed to move or be articulated. For example, tube sections 50A-50D can be rigidly secured to other components of system 12, such as structural elements (e.g. conveyer belt rails or box skids) of container erector 46, or fixed structures within the facility that system 12 is used, such as walls, ceilings or floors. Tube sections 54A-54D thereby provide rigid platforms upon which heating elements 54A-54C and temperature sensors 56A-56 can be mounted. Because tube sections 54A-54C are rigid and generally inflexible, pressure changes within each tube section do not induce stress and strain in heating elements 54A-54C and temperature sensors 56A-56 coupled thereto, thereby increasing the service life of such components.

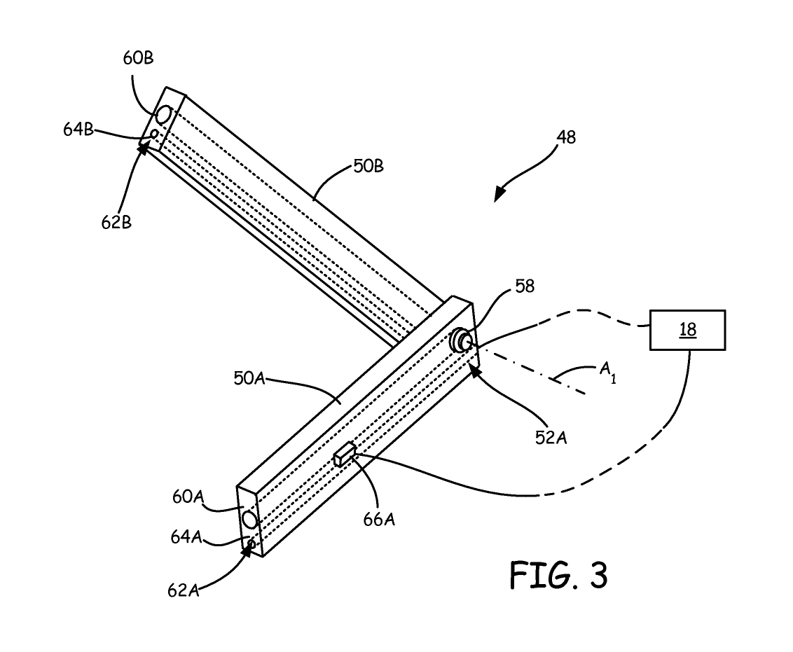

FIG. 3 is a perspective view of a first embodiment of joint 52A connecting tube sections 50A and 50B in heated articulating tubing system 48 of FIG. 2. In the embodiment shown in FIG. 3, joint 52A comprises pivot joint 58. Tube sections 50A and 50B include hot melt passages 60A and 60B and heating element passages 62A and 62B, respectively. Pivot joint 58 extends into bores entering tube sections 50A and 50B so as to transversely intersect passages 60A and 60B. Heating elements 64A and 64B are inserted into passages 60A and 60B, respectively. Temperature sensor 66A is connected to tube section 50A. Tube section 50B may also include a temperature sensor (not shown). Temperature sensor 66A and heating elements 64A and 64B are electrically connected to or controlled by controller 18.

In the embodiment shown, tube section 50A comprises a rectilinear pipe section having two internal passages defined by passages 60A and 62A. Passage 60A comprises a blind hole that extends into tube section 50A only as far as pivot joint 58. However, in other embodiments, passage 60A can extend all the way through tube section 50A and plugs can be used at one or both ends to facilitate connection with an articulating joint if needed. Passage 62A extends all the way through tube section 50A so as to permit entry of heating element 64A and to allow access for wires that connect to controller 18. Passage 62A and heating element 64A may extend beyond passage 60A and across pivot joint 58 such that heat from heating element 64A can be applied to joint 52A. However, in other embodiments, passage 62A can comprise a blind hole or can utilize plugs to facilitate connection with a heating element if needed.

Other than passages 60A and 62A and where pivot joint 58 is seated, tube section 50A comprises a substantially solid block of material. As such, material between passages 60A and 62A efficiently transfers heat from heating element 64A to passage 60A. Passage 62A is positioned in close proximity to passage 60A so as to further facilitate heat transfer between the passages. Temperature sensor 66A is positioned in close proximity to passage 60A so as to more accurately determine the temperature of liquid hot melt adhesive within tube section 50A. Temperature sensor 66A can be positioned anywhere along tube section 50A, including within passage 60A or 62A. Tube section 50B is configured the same as tube section 50B in the embodiment of FIG. 3.

Tube sections 50A and 50B may be comprised of any material suitable for transporting molten hot melt adhesive. In one embodiment, tube sections 50A and 50B are comprised of aluminum. However, other metals, alloys or materials, such as plastics or polymers, may be used. Heating elements 54A and 54B may comprise any suitable heating element as is known in the industry. For example, heating elements 54A and 54B may comprise electrical resistance heating elements. Elongate heating cartridges, such as those described in U.S. Pat. Nos. 5,575,941 and 3,937,923, may be inserted into passages 62A and 62B. Alternatively, strands of wire heating elements may be strung into passages 62A and 62B. Temperature sensor 66A may comprise any suitable sensor as is known in the industry, such as a thermocouple or an RTD (resistance temperature detector).

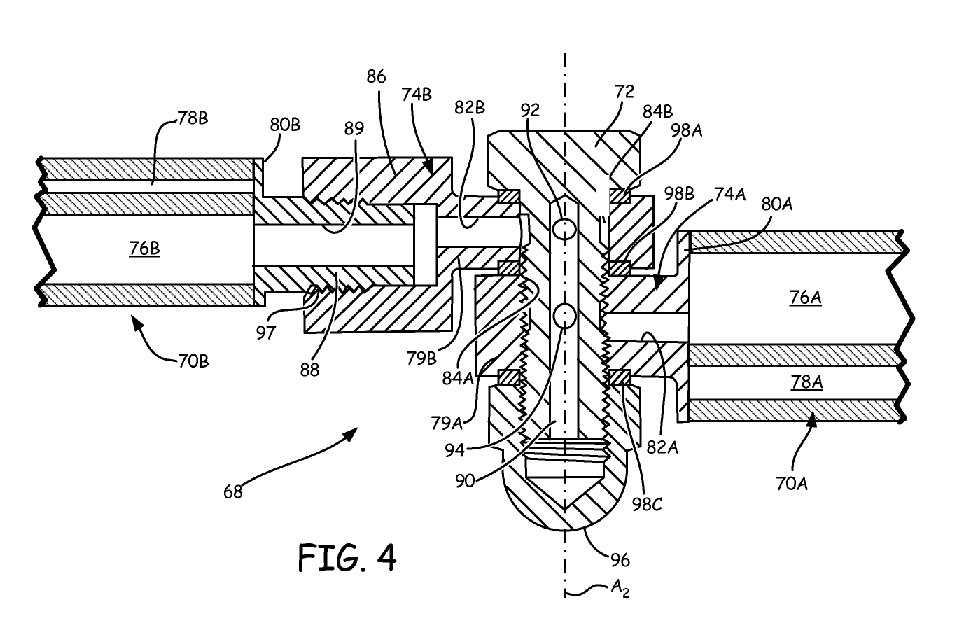

Pivot joint 58 couples tube sections 50A and 50B together such that each is rotatable relative to the other along an axis A₁. Pivot joint 58 permits each of tube sections 50A and 50B to rotate three-hundred-sixty degrees around axis A₁. Swivel joint 58 may comprise any connector as is known in the art. In one embodiment, swivel connector comprises a connector as shown in U.S. Pat. No. 5,330,106 to Braun, Jr., which is assigned to Graco Inc. For example, pivot joint 58 comprises a fastener that extends through tube sections 50A and 50B that includes a passage extending along axis A₁ and a plurality of circumferential ports intersecting that passage to intersect passages 60A and 60B in various positions. A swivel connector having a similar construction that is suitable for use with the present invention is shown and discussed with reference to FIG. 4.

FIG. 4 is a cross-sectional view of a second embodiment of joint 52A connecting tube sections 50A and 50B in heated articulating tubing system 48 of FIG. 2. In the embodiment of FIG. 4, joint 52A comprises swivel joint 68, which connects rigid tube sections 70A and 70B. Swivel joint 68 comprises fastener 72, swivel 74A and swivel 74B. Rigid tube sections 70A and 70B include fluid passages 76A and 76B, and heating element passages 78A and 78B, respectively. Passages 76A, 76B, 78A and 78B are configured similar to passages 60A, 60B, 62A and 62B described with reference to FIG. 3. Swivel 74A comprises neck 79A, flange 80A, fluid passage 82A and threaded bore 84A. Swivel 74B comprises neck 79B, flange 80B, fluid passage 82B and swivel passage 84B. Swivel 74B also includes swivel socket 86 and swivel pin 88, which includes fluid passage 89. Fastener 72 includes passage 90, port 92 and port 94, and is connected to nut 96.

Tube section 70A is coupled to flange 80A by any suitable means or is integral with flange 80A. Passage 76A within tube section 70A feeds into fluid passage 82A. Similarly, tube section 70B is coupled to flange 80B such that passage 76B feeds into fluid passage 89 of swivel pin 88. Swivel pin 88 is inserted into swivel socket 86 of swivel 74B. In one embodiment, swivel pin 88 is threaded into swivel socket 86 at rotatable joint 97. In another embodiment, swivel pin 88 is rotatably connected to swivel socket 86 such as with a snap connection or some other freely rotatable joint. Swivel 74B is positioned relative to swivel 74A such that swivel passage 84B aligns with threaded bore 84A along axis A₂. Fastener 72 is inserted into threaded bore 84A and swivel passages 84B to mechanically and fluidly join tube sections 70A and 70B. In one embodiment, fastener 72 is threaded into threaded bore 84A while swivel passage 84B is permitted to freely rotate about fastener 72. Nut 96 is threaded onto fastener 72 to prevent swivels 74A and 74B from separating from fastener 72. Fastener 72 includes passage 90 which extends along axis A₂. Ports 92 and 94 are positioned along fastener 72 so as to intersect passage 90 at the level of passages 82B and 82A, respectively. As such, a complete fluid path is formed by passage 76A, passage 82A, port 94, passage 90, port 92, passage 82B, passage 89 and passage 76B. Seals 98A, 98B and 98C may be positioned around fastener 72 adjacent necks 79A and 79B to seal along the fluid passage route. Connected as such, necks 79A and 79B are configured to rotate about axis A₂ so as to allow positioning of tube sections 70A and 70B relative to each other at different angles, while permitting uninterrupted fluid flow. Further, tube section 70B can rotate perpendicularly relative to axis A₂ at joint 97.

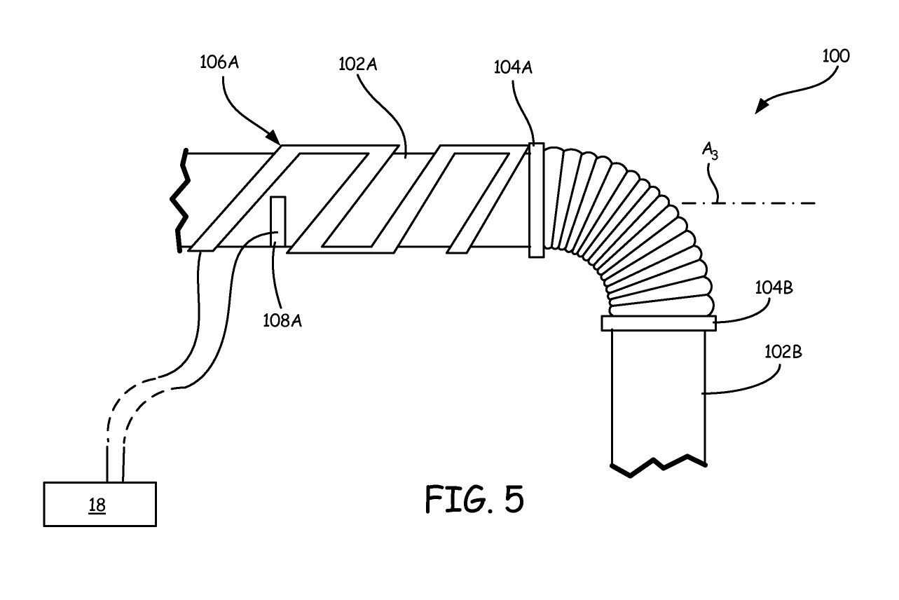

FIG. 5 is a perspective view of a third embodiment of articulating joint 52A connecting tube sections 50A and 50B in heated articulating tubing system 48 of FIG. 2. In the embodiment of FIG. 4, joint 52A comprises flexible coupling 100, which connects tube sections 102A and 102B. Flexible coupling 100 is jointed to tube sections 102A and 102B via clamps 104A and 104B. Tube section 102A is coupled to heating element 106A and temperature sensor 108A, which are in electronic communication with controller 18.

Tube sections 102A and 102B comprise hollow, cylindrical pipes formed of a rigid material, such as metal, steel aluminum or a polymer. Flexible coupling 100 comprises a length of flexible tubing of any suitable construction that permits tube section 102B to be positioned with two degrees of freedom relative to axis A₃. Specifically, tube section 102B can be positioned at any angle with respect to axis A₃ and can be positioned at any circumferential position about axis A₃. In various embodiments, flexible coupling 100 comprises a corrugated metal or plastic tubing, braided metal or plastic hose, or flexible stainless steel tubing. In other embodiments, flexible coupling 100 can be encased in a flexible sheathing to protect the enclosed fluid-conveying structure. Flexible coupling 100 is connected to tube sections 102A and 102B via clamps 104A and 104B, which may comprise any suitable connector as is known in the art. For example, clamps 104A and 104B may comprise hose clamps, draw latches, spring clamps or split rings.

Heating element 106A is wrapped around tube section 102A. In one embodiment of the invention, heating element 106A comprises a resistive heating element comprising braided wiring wrapped around tube section 102A in a spiral fashion. However, other types of flexible, stranded heating elements as are known in the art can be used and can be arranged about tube section 102A in other configurations. Heating element 106A can be secured to tube section 102A with any suitable means, such as an adhesive. The adhesive may be configured to facilitate heat transfer between heating element 106A and tube section 102A. Tube section 102B may be configured with a heating element and temperature sensor similarly to tube section 102A. If flexible coupling 100 is maintained small, or short in length, heating elements disposed on tube section 102A and 102B are sufficient to maintain hot melt adhesive within flexible join 100 in a molten state when traveling between tube sections 102A and 102B such that a separate heating element for flexible coupling 100 is not needed. However, in other embodiments of the invention, flexible coupling 100 may itself be wrapped with a heating element.

Because tube sections 102A and 102B are rigid or otherwise resistant to flexation, heating element 106A and sensor 108A are not subject to stresses and strains associated with expansion or ballooning of conventional flexible hoses. As such, the service life of heating element 106A and sensor 108A is increased.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims.

1. A heated fluid line comprising:
a first rigid segment;
a second rigid segment;
an articulating joint connecting the first rigid segment and the second rigid segment; and
a heating element connected to the first or second rigid segment.

2. The heated fluid line of claim 1 and further comprising:
a temperature sensor connected to the first or second rigid segment.

3. The heated fluid line of claim 1 wherein the heating element is wrapped around the first or second rigid segment.

4. The heated fluid line of claim 1 wherein the heating element is embedded in the first or second rigid segment.

5. The heated fluid line of claim 1 wherein the articulating joint comprises a flexible coupling.

6. The heated fluid line of claim 5 wherein:
the first and second rigid segments comprise annular pipes;
the flexible coupling comprises flexible tubing connecting the first rigid segment and the second rigid segment; and
the heating element comprises a flexible heating element wrapped around the annular pipes.

7. The heated fluid line of claim 1 wherein the articulating joint comprises a swivel joint.

8. The heated fluid line of claim 7 wherein:
the first and second rigid segments comprise tubes each comprising:
an internal fluid passageway; and
an internal heating element passageway;
the swivel joint comprises:
a fastener extending along an axis, the fastener comprising:
a fluid passage extending along the axis;
a first port extending into the fastener transverse to the fluid passage; and
a second port extending into the fastener transverse to the fluid passage;
a first swivel connected to the first rigid segment, the first swivel comprising:
a first bore for receiving the fastener; and
a first passage that aligns with the first port; and
a second swivel connected to the second rigid segment, the second swivel comprising:
a second bore for receiving the fastener; and
a second passage that aligns with the second port; and
the heating element comprises an elongate heating element disposed in one of the internal heating element passageways.

9. A hot melt dispensing system comprising:
a container for storing hot melt pellets;
a melter for heating hot melt pellets into liquid hot melt adhesive;
a feed system for transporting hot melt pellets from the container to the melter;
a dispensing system for administering liquid hot melt adhesive from the melter; and
a fluid line connecting the melter and the dispensing system, the fluid line comprising:
a rigid segment; and
a heating element connected to the rigid segment.

10. The hot melt dispensing system of claim 9 and further comprising a temperature sensor connected to the rigid segment.

11. The hot melt dispensing system of claim 9 wherein the heating element is wrapped around the rigid segment.

12. The hot melt dispensing system of claim 9 wherein the heating element is embedded in the rigid segment.

13. The hot melt dispensing system of claim 9 wherein the fluid line further comprises:
a first portion;
a second portion; and
an articulating joint connecting the first portion and the second portion.

14. The hot melt dispensing system of claim 13 wherein the articulating joint comprises a flexible coupling.

15. The hot melt dispensing system of claim 14 wherein:
the first and second portions comprise annular pipes;
the flexible coupling comprises flexible tubing connecting the first portion and the second portion; and
the heating element comprises a flexible heating element wrapped around the annular pipes.

16. The hot melt dispensing system of claim 13 wherein the articulating joint comprises a swivel joint.

17. The hot melt dispensing system of claim 16 wherein:
the first and second rigid segments comprise tubes each comprising:
an internal fluid passageway; and
an internal heating element passageway;
the swivel joint comprises:
a fastener extending along an axis, the fastener comprising:
a fluid passage extending along the axis;
a first port extending into the fastener transverse to the fluid passage; and
a second port extending into the fastener transverse to the fluid passage;
a first swivel connected to the first rigid segment, the first swivel comprising:
a first bore for receiving the fastener; and
a first passage that aligns with the first port; and
a second swivel connected to the second rigid segment, the second swivel comprising:
a second bore for receiving the fastener; and
a second passage that aligns with the second port; and
the heating element comprises an elongate heating element disposed in one of the internal heating element passageways.

18. The hot melt dispensing system of claim 9 wherein:
the heating element comprises a resistive heater; and
the temperature sensor comprises a resistive temperature detector.

19. The hot melt dispensing system of claim 1 wherein the dispensing system further comprises:
a dispensing unit having an orifice;
a pump comprising:
an inlet fluidly coupled to the melter; and
an outlet fluidly coupled to the dispensing unit.

20. The hot melt dispensing system of claim 19 wherein the fluid line connects the pump and the dispensing unit.

21. The hot melt dispensing system of claim 19 wherein the fluid line connects the melter and the pump.
